(19) United States
(12) Patent Application Publication
(10) Pub. No.: US 2014/0329007 A1
(43) Pub. Date: Nov. 6, 2014

(54) PROCESS FOR PRODUCING SINTERED R-T-B MAGNET

(71) Applicant: HITACHI METALS, LTD., Minato-ku, Tokyo (JP)

(72) Inventor: Tohru Obata, Yabu-shi (JP)

(21) Appl. No.: 14/362,140

(22) PCT Filed: Feb. 28, 2013
(86) PCT No.: PCT/JP2013/055411

§ 371 Date: Jun. 2, 2014

(30) Foreign Application Priority Data
Mar. 30, 2012 (JP) 2012-079305

(51) Int. Cl. H01F 41/02

(52) U.S. Cl. CPC H01F 41/0293
USPC 427/127

(57) ABSTRACT

A method according to the present disclosure includes the steps of: stacking RH diffusion sources and sintered R-T-B based magnet bodies alternately one upon the other with a flat plate holding member having openings interposed between each pair of the diffusion source and the magnet body, thereby forming a multilayer structure; loading the multilayer structure in a process vessel; (A) performing an RH supply-diffusion process at a pressure of 2.0 Pa to 50 Pa and at a temperature of 800° C. to 950° C. in the process vessel; and (B) performing an RH diffusion process at a pressure of 150 Pa to 2 kPa and at a temperature of 800° C. to 950° C. in the process vessel. The method includes the step of carrying out the steps (A) and (B) alternately and repeatedly at least twice.

### TECHNICAL FIELD

The present disclosure relates to a method for producing a sintered R-T-B based magnet.

### BACKGROUND ART

In this description, R of “R-T-B” is at least one of the rare-earth elements, T is at least one of the transition metal elements and always includes Fe, and B is boron. The rare-earth elements refer herein to the two elements of scandium (Sc) and yttrium (Y) and the fifteen elements (lanthanoids) of lanthanum (La) through lutetium (Lu) collectively.

A sintered R-T-B based magnet is known as a permanent magnet with the highest performance, and has been used in various types of motors such as a voice coil motor (VCM) for a hard disk drive and a motor for a hybrid car.

As a sintered R-T-B based magnet loses its coercivity HcJ (which will be simply referred to herein as “HcJ”) at high temperatures, such a magnet will cause an irreversible flux loss. For that reason, when used in a motor, for example, the magnet should maintain HcJ that is high enough even at elevated temperatures to minimize the irreversible flux loss.

Thus, to increase the HcJ of a sintered R-T-B based magnet, people proposed recently a method for increasing HcJ while minimizing a decrease in remanence Br (which will be simply referred to herein as “Br”) by supplying a heavy rare-earth element RH such as Dy or Tb onto the surface of the sintered R-T-B based magnet using evaporation means and diffusing that heavy rare-earth element RH inside the magnet. Such a method will be referred to herein as an “evaporation diffusion processing method”.

Patent Document No. 1 discloses an evaporation diffusion processing method as a method for diffusing a heavy rare-earth element RH inside a sintered R-T-B based magnet while supplying the heavy rare-earth element RH from a bulk body including the heavy rare-earth element RH onto the surface of the sintered R-T-B based magnet by arranging the sintered R-T-B based magnet and the bulk body so that the magnet and bulk body are spaced apart from each other with an Nb net and a spacer member interposed between them and by heating them to a predetermined temperature.

Patent Document No. 2 discloses another evaporation diffusion processing method which includes (A) an RH supplying process step for diffusing a heavy rare-earth element RH inside a sintered R-T-B based magnet body while supplying the heavy rare-earth element RH from an RH diffusion source, including the heavy rare-earth element RH, onto the surface of the sintered R-T-B based magnet body by loading the sintered R-T-B based magnet body, the RH diffusion source, and a supporting member made of a refractory metal into a process vessel so that they are spaced apart from each other by supporting poles and by heating the inside of the process vessel to a predetermined temperature and (B) an RH diffusion process step in which the supply of the heavy rare-earth element RH from the RH diffusion source onto the sintered magnet body is suspended with the sintered R-T-B based magnet body kept heated, and in which these process steps (A) and (B) are repeatedly performed at least twice.

### CITATION LIST

### Patent Literature

Patent Document No. 1: PCT International Application Publication No. 2007/102391
Patent Document No. 2: Japanese Laid-Open Patent Publication No. 2011-233554

### SUMMARY OF INVENTION

### Technical Problem

According to Patent Document No. 1, a layer including the heavy rare-earth element RH at a high concentration is formed on the outer periphery of the main phase of the sintered R-T-B based magnet by the evaporation diffusion processing method. In this process, while the heavy rare-earth element RH is diffusing inside the sintered R-T-B based magnet from its surface, a liquid phase component which consists mostly of a light rare-earth element RL (which is at least one of Nd and Pr and) which is included inside the sintered R-T-B based magnet diffuses toward the surface of the sintered R-T-B based magnet. As such inter-diffusion advances so that while the heavy rare-earth element RH is diffusing inside the sintered R-T-B based magnet from its surface, the light rare-earth element RL diffuses from inside of the sintered R-T-B based magnet toward its surface, a liquated portion consisting mostly of the light rare-earth element RL is formed on the surface of the sintered R-T-B based magnet. Such a portion could stick (which will be referred to herein as “adhere”) to the Nb net that supports the sintered R-T-B based magnet.

According to the method disclosed in Patent Document No. 2, in the RH supplying process step (A), the same evaporation diffusion processing as what is disclosed in Patent Document No. 1 is carried out. That is why as in the method disclosed in Patent Document No. 1, the supporting member and the sintered R-T-B based magnet could also adhere to each other.

If the heavy rare-earth element RH were supplied excessively to the sintered R-T-B based magnet, such inter-diffusion and adhesion would occur frequently. For that reason, according to Patent Documents Nos. 1 and 2, in order to avoid supplying the heavy rare-earth element RH too much to the sintered R-T-B based magnet, spacer members (corresponding to the strut disclosed in Patent Document No. 2) are arranged between an Nb net that carries the sintered R-T-B based magnets thereon (and that corresponds to the holding member disclosed in Patent Document No. 2) and the bulk bodies (corresponding to the RH diffusion sources disclosed in Patent Document No. 2) and between an Nb net that carries the bulk bodies thereon and the sintered R-T-B based magnets, thereby leaving a space between them. As a result, however, when a lot of sintered R-T-B based magnets need to be processed, the number of magnets that can be handled in a single process cannot be increased, which is a problem.

An embodiment of the present disclosure can provide a method for producing sintered R-T-B based magnets by which an increased number of magnets can be handled in a single process, and eventually the productivity can increased, without allowing the sintered R-T-B based magnets to adhere to the holding members.

### Solution to Problem

A method for producing a sintered R-T-B based magnet according to the present disclosure is characterized by including the steps of: stacking RH diffusion sources (each being a metal or alloy, of which at least 80 at % is a heavy rare-earth element RH that is at least one of Dy and Tb) and sintered R-T-B based magnet bodies (where R is at least one of the rare-earth elements and T is at least one of the transition metal elements and always includes Fe) alternately one upon the other with a flat plate holding member having openings interposed between each pair of the diffusion source and the magnet body, thereby forming a multilayer structure; loading the multilayer structure in a process vessel; (A) performing an RH supply-diffusion process at a pressure of 2.0 Pa to 50 Pa and at a temperature of 800° C. to 950° C. in the process vessel; and (B) performing an RH diffusion process at a pressure of 150 Pa to 2 kPa and at a temperature of 800° C. to 950° C. in the process vessel. The method includes the step of carrying out the steps (A) and (B) alternately and repeatedly at least twice.

In one embodiment, the holding member has a thickness of 0.1 mm to 4 mm.

In one embodiment, the method further includes the step of cooling the temperature in the process vessel to 500° C. at a cooling rate of 1° C./min to 15° C./min after the steps (A) and (B) have been alternately carried out at least twice.

In one embodiment, the process vessel is subjected to an evacuation process using either a rotary pump alone or a rotary pump and a mechanical booster pump in combination.

### Advantageous Effects of Invention

According to an embodiment of the present disclosure, the step of performing an RH supply-diffusion process at a pressure of 2.0 Pa to 50 Pa and the step of performing an RH diffusion process at a pressure of 150 Pa to 2 kPa are performed alternately and repeatedly at least twice, thereby preventing the heavy rare-earth element RH from being supplied onto the sintered R-T-B based magnet bodies at a time and avoiding supplying the heavy rare-earth element RH excessively. As a result, the sintered R-T-B based magnet bodies would not adhere to the holding members. Consequently, the sintered R-T-B based magnet bodies and the RH diffusion sources can be directly stacked one upon the other with a flat-plate holding member having openings interposed between each pair of them, an increased number of the sintered R-T-B based magnet bodies can be handled per RH supply-diffusion process and per RH diffusion process, and eventually the productivity can be increased.

### BRIEF DESCRIPTION OF DRAWINGS

FIG. 1 Illustrates an exemplary configuration for a multilayer structure according to the present disclosure.

FIG. 2 Illustrates an exemplary configuration for a multilayer structure according to the present disclosure.

FIG. 3 Illustrates how sintered R-T-B based magnet bodies may be arranged onto a holding member.

FIG. 4 Illustrates how RH diffusion sources may be arranged onto a holding member.

FIG. 5 Illustrates how Step (A) of performing an RH supply-diffusion process and Step (B) of performing an RH diffusion process may or may not be carried out repeatedly, wherein (a) shows an exemplary situation where Steps (A) and (B) are not carried out repeatedly (but completed in one cycle), (b) shows an exemplary situation where Steps (A) and (B) are carried out repeatedly three times (and completed in three cycles), and (c) shows an exemplary situation where Steps (A) and (B) are carried out repeatedly six times (and completed in six cycles).

### DESCRIPTION OF EMBODIMENTS

According to an embodiment of the present disclosure, after the step (A) of performing an RH supply-diffusion process within the particular pressure range described above has been carried out, the step (B) of performing an RH diffusion process in a higher pressure range than the former pressure range is carried out, and these steps (A) and (B) are performed alternately and repeatedly at least twice. Specifically, in the step (A), the RH supply-diffusion process is performed with an ambient having a pressure of 2.0 Pa to 50 Pa and a temperature of 800° C. to 950° C. created within a process vessel, thereby avoiding supplying the heavy rare-earth element RH too much from the RH diffusion sources to the sintered R-T-B based magnet bodies. However, even if the supply of the heavy rare-earth element RH is reduced during the RH supply-diffusion process but if the heavy rare-earth element RH that needs to be used to realize the intended magnetic properties is supplied continuously, the supply will still get excessive gradually and adhesion will occur after all. That is why according to the present disclosure, the RH supply-diffusion process is carried out a number of times separately and the RH diffusion process is carried out every time the RH supply-diffusion process gets done, thereby causing the “supply and diffusion” and “diffusion” repeatedly. As a result, it is possible to prevent the heavy rare-earth element RH that needs to be used to realize the intended magnetic properties from being supplied excessively. It should be noted that unless the excessive supply of the heavy rare-earth element RH is reduced in the process step of performing the RH supply-diffusion process, the adhesion will sill occur even if the step of performing the RH supply-diffusion process and the step of performing an RH diffusion process are simply performed repeatedly twice or more. The effect of minimizing the adhesion cannot be achieved so significantly just by causing the “supply and diffusion” and “diffusion” repeatedly. Thus, according to the present disclosure, after the pressure has been set to fall within a particular pressure range in the step of performing an RH supply-diffusion process, the step of performing the RH supply-diffusion process and the step of performing an RH diffusion process are carried out alternately and repeatedly at least twice, thereby eliminating the adhesion.

In the present disclosure, the process of supplying a heavy rare-earth element RH from an RH diffusion source onto the surface of an sintered R-T-B based magnet body and causing the heavy rare-earth element RH to diffuse inside of the sintered R-T-B based magnet body in parallel will be referred to herein as an “RH supply-diffusion process”. On the other hand, the process of just causing the heavy rare-earth element RH to diffuse inside of the sintered R-T-B based magnet body without supplying the heavy rare-earth element RH from the RH diffusion source will be referred to herein as an “RH diffusion process”. And the heat treatment to be carried out in order to improve the magnetic properties of the sintered R-T-B based magnet after the RH supply-diffusion process and the RH diffusion process have been carried out repeatedly twice or more will be simply referred to herein as a “heat treatment”.

Also, in the present disclosure, a sintered R-T-B based magnet which has not been subjected to the RH supply-diffusion process and the RH diffusion process repeatedly yet, or which is being subjected to the RH supply-diffusion process or the RH diffusion process will be referred to herein as “sintered R-T-B based magnet body”. On the other hand, the sintered R-T-B based magnet which has already gone through the RH supply-diffusion process and the RH diffusion process a number of times will be referred to herein as an “sintered R-T-B based magnet” to avoid confusion.

[RH Diffusion Source]

The RH diffusion source is either a metal or alloy including 80 at % or more of a heavy rare-earth element RH that is at least one of Dy and Tb. Examples of the heavy rare-earth elements RH include Dy metal, Tb metal, a DyFe alloy and a TbFe alloy. Any arbitrary element other than Dy, Tb and Fe may be included as well. The RH diffusion source suitably includes 80 at % or more of the heavy rare-earth element RH. The reason is that if the content of the heavy rare-earth element RH were less than 80 at %, then the rate of supplying the heavy rare-earth element RH from the RH diffusion source would decrease so much that it would take a very long time to get done the process to increase HcJ significantly as intended.

The RH diffusion source may have a plate shape, a block shape or any other arbitrary shape and its size is not particularly limited. To increase the rate of the RH supply-diffusion process, however, the RH diffusion source suitably has a plate shape with a thickness of 0.5 mm to 5.0 mm.

In this case, unless the effect of the present disclosure is marred, the RH diffusion source may include at least one element selected from the group consisting of Nd, Pr, La, Ce, Zn, Zr, Sn, Co, Al, Fe, F, N and O.

[Sintered R-T-B Based Magnet Body]

The sintered R-T-B based magnet body may have a known composition and may be made by a known manufacturing process.

### [Step of Forming Multilayer Structure]

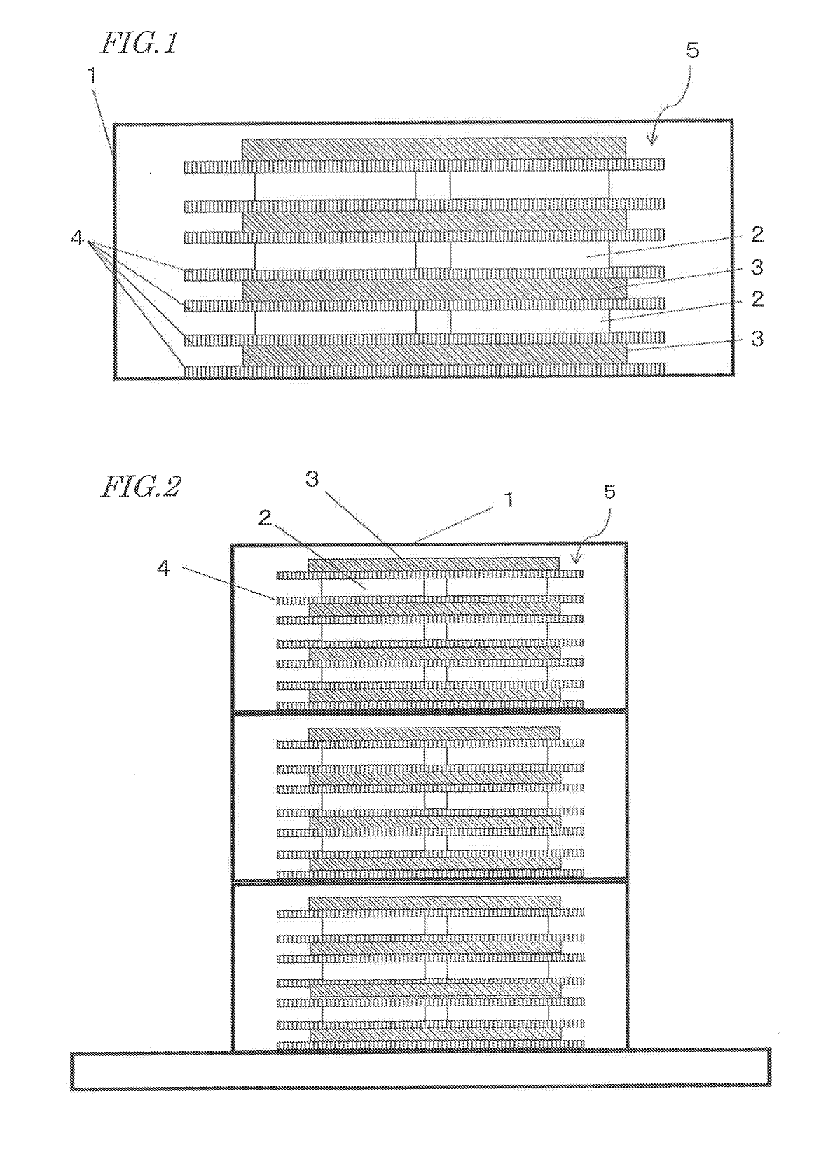

According to the present disclosure, before the step of performing an RH supply-diffusion process is carried out, RH diffusion sources and sintered R-T-B based magnet bodies are alternately stacked one upon the other in a process vessel, thereby forming a multilayer structure (stack) 5. Specifically, as shown in FIG. 1, a holding member 4, an RH diffusion source 3, another holding member 4, sintered R-T-B based magnet bodies 2, still another holding member 4, another RH diffusion source 3, yet another holding member 4, and sintered R-T-B based magnet bodies 2 are stacked one upon the other in this order on the bottom of the process vessel 1, thereby forming a multilayer structure 5. By adjusting the thickness of the holding members 4, the interval between the sintered R-T-B based magnet bodies 2 and the RH diffusion sources 3 can be controlled.

By stacking a number of such multilayer structures 5 one upon the other in the process vessel 1 as shown in FIG. 2, a lot of sintered R-T-B based magnet bodies 2 can be subjected to the RH supply-diffusion process and the RH diffusion process at a time.

The holding members 4 to hold the sintered R-T-B based magnet bodies 2 and the RH diffusion sources 3 are flat-plate members with openings. The holding members 4 may be an Nb net or an Mo net, for example. The holding members 4 suitably have a thickness of 0.1 mm to 4 mm. The reason is that if the holding members 4 had a thickness of less than 0.1 mm, such thin holding members would be difficult to make from an industrial point of view and might be unable to hold the sintered R-T-B based magnet bodies 2 and the RH diffusion sources 3 due to its low mechanical strength. Optionally, the flat-plate holding members 4 may have walls or projections which stand upright with respect to their flat-plate portion.

According to the present disclosure, the RH supply-diffusion process is carried out at a pressure of 2.0 Pa to 50 Pa in the process vessel 1, and therefore, the heavy rare-earth element RH will not be supplied too much from the RH diffusion sources 3. For that reason, if the thickness exceeded 4 mm, then the sintered R-T-B based magnet bodies 2 would be too distant from the RH diffusion sources 3 and the heavy rare-earth element RH would be supplied too little from the RH diffusion sources 3 to the sintered R-T-B based magnet bodies 2 and the RH supply-diffusion process could not be carried out sufficiently. The opening ratio of the holding members 4 is suitably at least 50% to get the RH supply-diffusion process done efficiently, and more suitably 70% or more.

The process vessel 1 and the holding members 4 are suitably made of a material that would not be deformed or denatured easily during the RH supply-diffusion process or the RH diffusion process. Examples of such materials include Nb, Mo, W, Ta and other refractory metals and boron nitride, zirconia, alumina, yttria, calcia, magnesia, and other ceramic materials.

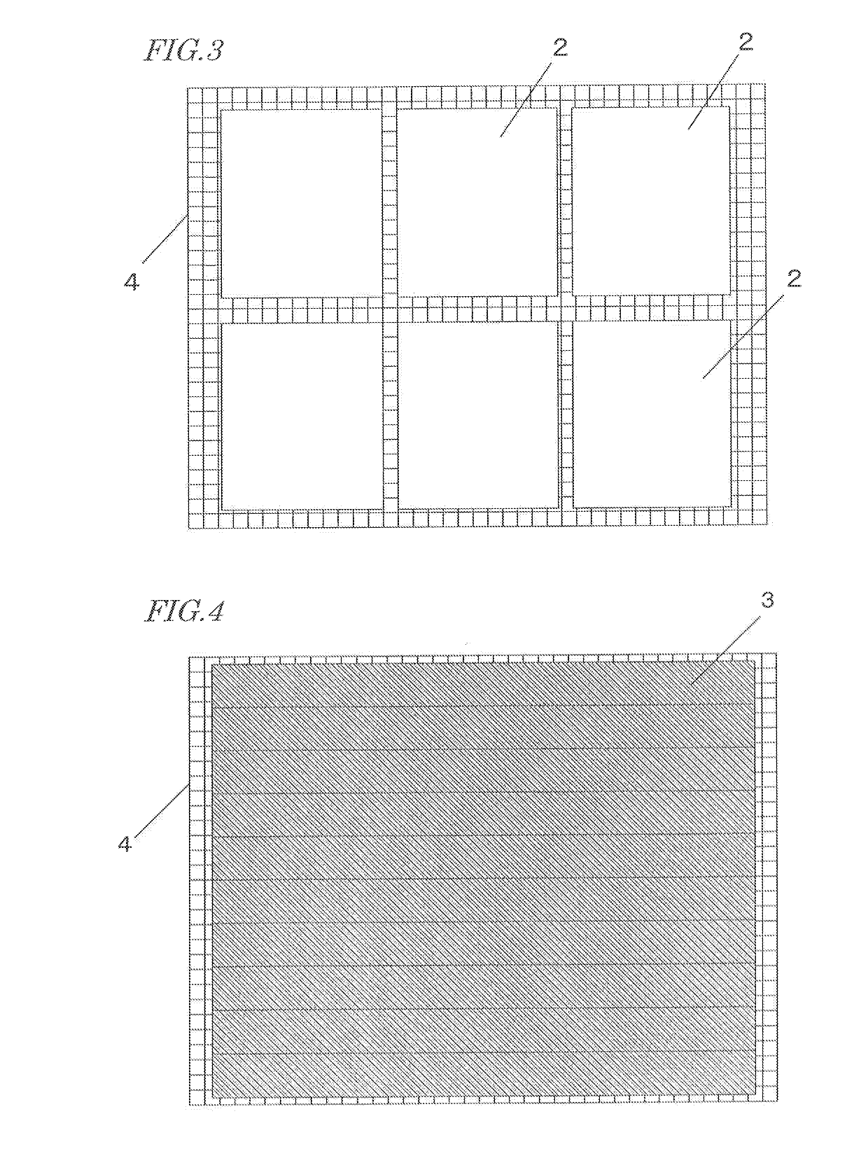

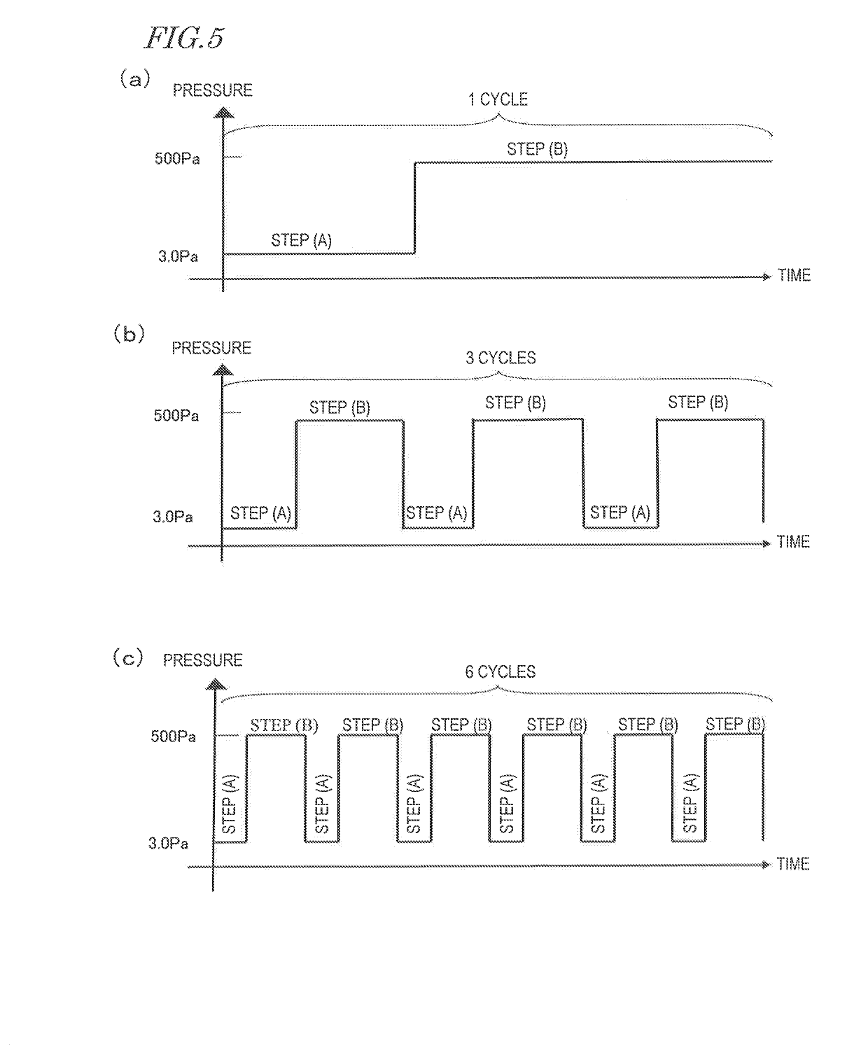

As shown in FIG. 3, the sintered R-T-B based magnet bodies 2 are suitably arranged on the holding member 4 at some intervals in order to prevent adjacent ones of the sintered R-T-B based magnet bodies 2 from adhering to each other with the light rare-earth element RL that has liquated as a result of the RH supply-diffusion process. The RH diffusion sources 3, on the other hand, may also be arranged on the holding member 4 at some intervals just like the sintered R-T-B based magnet bodies 2 or may be arranged with no gap left at all as shown in FIG. 4. The arrangement of the RH diffusion sources 3 may be determined appropriately according to the arrangement of the sintered R-T-B based magnet bodies 2. In an embodiment, a plurality of diffusion sources or magnet bodies which have substantially the same height are arranged on each layer so that the respective layers of the multilayer structure have a uniform thickness.

[Step of Performing RH Supply-Diffusion Process]

The RH supply-diffusion process is carried out by loading the multilayer structure into a process vessel and by creating an ambient with a pressure of 2.0 Pa to 50 Pa and a temperature of 800° C. to 950° C. within the process vessel. Specifically, sintered R-T-B based magnet bodies and RH diffusion sources are heated, thereby causing the heavy rare-earth element RH to diffuse inside of the sintered R-T-B based magnet bodies while supplying the heavy rare-earth element RH from the RH diffusion sources onto the surface of the sintered R-T-B based magnet bodies. In the following description, the step of performing this RH supply-diffusion process will be referred to herein as “Step (A)”.

In Step (A), if the pressure in the process vessel were less than 2.0 Pa, the sintered R-T-B based magnet bodies would adhere to the holding member more easily. However, if the pressure were higher than 50 Pa, then the heavy rare-earth element RH could not be supplied to the sintered R-T-B based magnet bodies much enough to achieve the effect of increasing HcJ as intended.

In Step (A), if the temperature in the process vessel were less than 800° C., the heavy rare-earth element RH could not be supplied to the sintered R-T-B based magnet bodies sufficiently. However, if the temperature were higher than 950° C., then the sintered R-T-B based magnet bodies would adhere to the holding member even when the pressure in the process vessel falls within the range of 2.0 Pa to 50 Pa.

[Step of Performing RH Diffusion Process]

After Step (A) has been carried out, an RH diffusion process is carried out with the pressure in the process vessel increased to a level of 150 Pa to 2 kPa which is higher than the vapor pressure of the heavy rare-earth element RH. That is to say, with the supply of the heavy rare-earth element RH from the RH diffusion sources decreased significantly, the heavy rare-earth element RH is only allowed to diffuse inside of the sintered R-T-B based magnet bodies. In the following description, the step of performing this RH diffusion process will be referred to herein as “Step (B)”.

In this Step (B), if the pressure in the process vessel were less than 150 Pa, the supply of the heavy rare-earth element RH could not be decreased sufficiently. The pressure in the process vessel is supposed to be at most 2 kPa. This upper limit is set in order to increase the mass productivity by performing this series of Steps (A) and (B) repeatedly and smoothly. If the mass productivity is not a primary concern, the pressure inside the process vessel may exceed 2 kPa (e.g., equal to the atmospheric pressure).

In this Step (B), the supply of the heavy rare-earth element RH does not have to be stopped entirely. Rather, the effect of the present disclosure can be achieved as long as the supply of the heavy rare-earth element RH from the RH diffusion sources is decreased sufficiently.

Also, in this Step (B), the temperature in the process vessel does not have to be as high as the temperature in the previous Step (A) but may fall within the range of 800° C. to 950° C. From the standpoint of productivity, however, Step (B) is suitably carried out at the same temperature as Step (A). In this description, if two temperatures are “the same”, it means herein that the difference between those two temperatures is within 20° C.

[Step of Performing Steps (A) and (B) Alternately Twice or More]

Next, Step (A) of performing the RH supply-diffusion process and Step (B) of performing the RH diffusion process are carried out alternately twice or more. FIG. 5 illustrates how these Steps (A) and (B) may be carried out repeatedly in a situation where Dy is used as the heavy rare-earth element RH. FIG. 5(a) illustrates an exemplary conventional process in which Steps (A) and (B) are carried out for three hours and six hours, respectively, only once (i.e., for only one cycle) and non-repeatedly. FIG. 5(b) illustrates an example of the present disclosure in which Steps (A) and (b) are repeatedly carried out three times (i.e., for three cycles) for one hour and two hours, respectively, each time. And FIG. 5(c) illustrates an example of the present disclosure in which Steps (A) and (b) are repeatedly carried out six times (i.e., for six cycles) for 0.5 hours and one hour, respectively, each time. No matter how many times (i.e., no matter how many cycles) these Steps (A) and (B) are carried out repeatedly, the total processing time of Step (A) is always three hours and the total processing time of Step (B) is always six hours in any of FIGS. 5(a) to 5(c). In Step (A), the pressure in the process vessel is controlled at 2.0 Pa. On the other hand, in Step (B), the pressure in the process vessel is set to be 500 Pa. In these Steps (A) and (B), the process temperature is kept constant (at 900° C.) and Dy is supplied discontinuously by controlling the pressure.

In the examples illustrated in FIGS. 5(b) and 5(c), the total process times of Steps (A) and (B) are set to be three hours and six hours, respectively, and each of these Steps (A) and (B) is supposed to have a constant process time in order to compare these examples to the exemplary conventional process shown in FIG. 5(a). However, this is just an example of the present disclosure and no way limiting. Alternatively, the processing time(s) of Step(s) (A) and/or (B) may be changed on a cycle-by-cycle basis. Also, the total process time may be set appropriately according to the amount of Dy to be supplied and the shape and size of the sintered R-T-B based magnet bodies. Likewise, the process temperature does not always have to be kept constant, either. For example, if the same series of steps are repeatedly performed for six cycles, the process temperature may be maintained at 900° C. for the first three cycles and at 850° C. for the last three cycles.

Each of these Steps (A) and (B) suitably has a total process time of 20 minutes to 20 hours. The reason is that if the total process time were less than 20 minutes, the effect of increasing HcJ could not be achieved as intended. On the other hand, if the total process time were longer than 20 hours, then the process time would be too long to avoid increasing the overall manufacturing cost. Also, each of these Steps (A) and (B) suitably has a process time of three minutes to three hours for a single cycle. The reason is that if the process time per cycle were less than three minutes, the pressure should be changed between Steps (A) and (B) too many times to avoid increasing the manufacturing cost. On the other hand, if the process time per cycle were longer than three hours, then the process time would be too long to avoid increasing the overall manufacturing cost. Furthermore, in Step (A), adhesion might be caused, too. The process time does not always have to be these values but may also be determined appropriately according to the quantities of the sintered R-T-B based magnet bodies and RH diffusion sources loaded, their shapes, the process pressure, the process temperature and other parameters.

HcJ can be further increased by performing Steps (A) and (B) alternately and repeatedly twice or more and then cooling the temperature in the process vessel to 500° C. at a cooling rate of 1° C./min to 15° C./min. If the cooling rate were less than 1° C./min, the cooling process time would be too long to avoid increasing the overall manufacturing cost. However, if the cooling rate were more than 15° C./min, then the effect of increasing HcJ could not be achieved simply by adjusting the cooling rate.

[Heat Treatment]

After the step of performing Steps (A) and (B) alternately twice or more has been carried out, the sintered R-T-B based magnets may be subjected to a heat treatment in order to improve their magnetic properties. This heat treatment may be the same as the heat treatment to be carried out after sintering in a known process of producing sintered R-T-B based magnet bodies. Known conditions may be adopted as the ambient and temperature of the heat treatment, for example.

[Processing Apparatus]

The processing apparatus for conducting the RH supply-diffusion process or the RH diffusion process may be a known batch type heat treatment furnace or continuous heat treatment furnace. According to the present disclosure, the RH supply-diffusion process and RH diffusion process can be carried out at a relatively high pressure of about 2.0 Pa or more, and therefore, an expensive pump that produces a low pressure of 10⁻² Pa or less such as a Cryo-pump or an oil diffusion pump is not necessarily needed, but the process can be carried out using a cheap pump such as a rotary pump or a combination of a rotary pump and a mechanical booster pump.

[Grinding and Surface Treatment]

Optionally, after having gone through the step of performing Steps (A) and (B) alternately twice or more, the sintered R-T-B based magnets may be ground to have their size adjusted. Even after having gone through such a process, their magnetic properties can still be improved almost as effectively. For the purpose of size adjustment, the sintered magnets are suitably ground to a depth of 1 μm to 300 μm, more suitably to a depth of 5 μm to 100 μm, and even more suitably to a depth of 10 μm to 30 μm. The sintered R-T-B based magnets that have gone through the step of performing Steps (A) and (B) alternately twice or more are suitably subjected to some surface treatment, which may be a known one such as Al evaporation, electrical Ni plating or resin coating. Before the surface treatment, the sintered magnets may also be subjected to a known pre-treatment such as sandblast abrasion process, barrel abrasion process, mechanical grinding or acid cleaning.

### Example 1

A sintered R-T-B based magnet body, of which the composition included 22.3 mass % of Nd, 6.2 mass % of Pr, 4.0 mass % of Dy, 1.0 mass % of B, 0.9 mass % of Co, 0.1 mass % of Cu, 0.2 mass % of Al, 0.1 mass % of Ga and Fe as the balance, was made. When the sintered R-T-B based magnet bodies thus obtained had their magnetic properties measured after having been subjected to a heat treatment, Br was 1.35 T and HcJ was 1730 kA/m.

The sintered R-T-B based magnet bodies were machined to have a thickness of 5 mm, a width of 40 mm, and a length of 60 mm each. As the RH diffusion sources, Dy metal with a thickness of 3 mm, a width of 27 mm, and a length of 270 mm was provided. As the holding member, a four-mesh flat-plate Mo net with a thickness of 2 mm, a width of 300 mm and a length of 400 mm was provided. By setting the thickness of the holding member to be 2 mm, the distance between the sintered R-T-B based magnet bodies and the RH diffusion sources was set to be 2 mm.

Then, the sintered R-T-B based magnet bodies 2 and the RH diffusion sources 3 were stacked one upon the other with the holding members 4 interposed between them as shown in FIG. 1. The process vessel had a height of 60 mm, a width of 320 mm, and a length of 420 mm.

After the temperature in the process vessel 1 was increased to 900° C., the RH supply-diffusion process (for half an hour each time) and the RH diffusion process (for an hour each time) were carried out for six cycles. The pressure in the process vessel was controlled at 3.0 Pa during the RH supply-diffusion process and at 1.5 kPa during the RH diffusion process, respectively. A rotary pump and a mechanical booster pump were used in combination to carry out the RH supply-diffusion process, and a rotary pump was used to carry out the RH diffusion process.

After the RH supply-diffusion process and the RH diffusion process were carried out for six cycles, the temperature in the process vessel was rapidly cooled with a gas from 900° C. to 500° C. at a rate of 80° C./min. After that, a heat treatment was conducted at a pressure of 2 Pa and at a temperature of 500° C. for 60 minutes, thereby making sintered R-T-B based magnets.

### Example 2

Sintered R-T-B based magnets were made on the same condition as in Example 1 except that the RH supply-diffusion process (for an hour each time) and the RH diffusion process (for two hours each time) were carried out for three cycles.

### Example 3

Sintered R-T-B based magnets were made on the same condition as in Example 1 except that after the RH supply-diffusion process and the RH diffusion process had been carried out repeatedly, the temperature in the process vessel was cooled from 900° C. to 500° C. at a cooling rate of 3° C./min and then rapidly cooled with a gas from 500° C. to room temperature (at a rate of 80° C./min), instead of rapidly cooling the temperature in the process vessel with a gas from 900° C. to 500° C. (at a rate of 80° C./min).

### Comparative Example 1

Sintered R-T-B based magnets were made on the same condition as in Example 1 except that the RH supply-diffusion process (for three hours) and the RH diffusion process (for six hours) were carried out for one cycle.

### Comparative Example 2

Sintered R-T-B based magnets were made on the same condition as in Example 1 except that the pressure in the process vessel during the RH supply-diffusion process was changed from 3.0 Pa to 10⁻³ Pa using an oil diffusion pump.

### Comparative Example 3

Sintered R-T-B based magnets were made on the same condition as in Example 1 except that the pressure in the process vessel during the RH supply-diffusion process was changed from 3.0 Pa to 10⁻³ Pa using an oil diffusion pump and that the RH supply-diffusion process (for three hours) and the RH diffusion process (for six hours) were carried out for one cycle.

### Comparative Example 4

Sintered R-T-B based magnets were made on the same condition as in Example 1 except that the pressure in the process vessel during the RH supply-diffusion process was changed from 3.0 Pa to 10⁻³ Pa using an oil diffusion pump, that the RH supply-diffusion process (for three hours) and the RH diffusion process (for six hours) were carried out for one cycle, that the holding member had a thickness of 8 mm and that the distance between the sintered R-T-B based magnet bodies 2 and the RH diffusion sources 3 was changed from 2 mm to 8 mm.

### Comparative Example 5

Sintered R-T-B based magnets were made on the same condition as in Example 1 except that the pressure in the process vessel during the RH supply-diffusion process was changed from 3.0 Pa to 40000 Pa and that the RH supply-diffusion process (for three hours) and the RH diffusion process (for six hours) were carried out for one cycle.

The results of Examples 1 to 3 and Comparative Examples 1 to 5 are summarized in the following Table 1. The “RH supply-diffusion process pressure” indicates the pressure in the process vessel during the RH supply-diffusion process. The “distance” indicates the distance between the sintered R-T-B based magnet bodies 2 and the RH diffusion sources 3. The “total RH supply-diffusion process time” indicates the total time of the RH supply-diffusion process. The “total RH diffusion process time” indicates the total time of the RH diffusion process. The “number of cycles” was counted one when the RH diffusion process was carried out once after the RH supply-diffusion process had been done. The “number of magnet bodies processed” indicates how many sintered R-T-B based magnet bodies 2 were processed in each of Examples 1 to 3 and Comparative Examples 1 to 5. “HcJ” indicates the HcJ of the sintered R-T-B based magnets processed. “Br” indicates the Br of the sintered R-T-B based magnets processed. And the “number of adhesions” indicates how many magnets had a trace of adhesion when the sintered R-T-B based magnets were removed from the holding members 4.

TABLE 1

| | RH supply- | | Total RH | | | | | | |
|---|---|---|---|---|---|---|---|---|---|
| | diffusion | | supply- | Total RH | | | | | |
| | process | | diffusion | diffusion | | No. of | | | |
| | pressure | Distance | process time | process time | No. of | magnets | HcJ | Br | No. of |
| | (Pa) | (mm) | (hours) | (hours) | cycles | processed | (kA/m) | (T) | adhesions |
| Ex. 1 | 3.0 | 2 | 3 | 6 | 6 | 168 | 1985 | 1.35 | 0 |
| Ex. 2 | 3.0 | 2 | 3 | 6 | 3 | 168 | 1980 | 1.35 | 0 |
| Ex. 3 | 3.0 | 2 | 3 | 6 | 6 | 168 | 2125 | 1.35 | 0 |
| Cmp. Ex. 1 | 3.0 | 2 | 3 | 6 | 1 | 168 | 1970 | 1.35 | 15 |
| Cmp. Ex. 2 | 10⁻³ | 2 | 3 | 6 | 6 | 168 | 1990 | 1.35 | 148 |
| Cmp. Ex. 3 | 10⁻³ | 2 | 3 | 6 | 1 | 168 | Immeasurable | Immeasurable | Everything |
| Cmp. Ex. 4 | 10⁻³ | 8 | 3 | 6 | 1 | 126 | 1990 | 1.35 | 45 |
| Cmp. Ex. 5 | 40000 | 2 | 3 | 6 | 1 | 168 | 1730 | 1.35 | 0 |

As can be seen from Table 1, in Examples 1 to 3 in which the RH supply-diffusion process pressure was set to be 3.0 Pa, a high HcJ was achieved, Br did not decrease, and there were no traces of adhesion. Even if the RH supply-diffusion process pressure was 3.0 Pa as in Comparative Example 1 but if the number of cycles was only one, some (e.g., fifteen in this example) traces of adhesion were seen. On the other hand, in Comparative Examples 2 to 4 in which the RH supply-diffusion process pressure was set to be 10⁻³ Pa, a lot of (e.g., 148 in this example) traces of adhesion were seen even if the number of cycles was six as in Comparative Example 2. And if the number of cycles was one as in Comparative Example 3, the sintered R-T-B based magnets could not be removed from the holding members due to the adhesion. In Comparative Example 4 in which the thickness of the holding members was set to be 8 mm and the distance between the sintered R-T-B based magnets and the RH diffusion sources was increased, the number of traces of adhesion decreased compared to Comparative Examples 2 and 3, but the number of magnets processed also decreased (from 168 to 126) because the distance had been increased. Furthermore, in Comparative Example 5 in which the RH supply-diffusion process pressure was set to be 40000 Pa, there were no traces of adhesions but a high HcJ could not be achieved.

As can be seen from these results, the methods of Examples 1 to 3 will contribute to mass production greatly, and can process an increased number of magnets per RH diffusion process without allowing the sintered R-T-B based magnet bodies to adhere to the holding members. Comparing the results obtained in Example 1 in which the magnets were cooled with gas from 900° C. to 500° C. (at a rate of 80° C./min) to the ones obtained in Example 3 in which the magnets were initially cooled slowly from 900° C. to 500° C. at a rate of 3° C./min and then rapidly cooled from 500° C. to room temperature at a rate of 80° C./min, a higher HcJ could be obtained in Example 3.

### Example 4

The following Table 2 shows the respective conditions for the cooling process to be performed in the process vessel after the RH supply-diffusion process and the RH diffusion process had been carried out repeatedly six times under the same condition as in Example 1. In Table 2, the respective “cooling conditions” (1) through (9) indicate the rates of cooling the temperature (900° C.) in the process vessel after the RH supply-diffusion process and the RH diffusion process had been carried out repeatedly six times to 500° C. In any of these cases, the temperature was rapidly cooled with gas from 500° C. to room temperature at a rate of 80° C./min. In the present disclosure, the “room temperature” refers herein to the range of 20° C.±15° C. “HcJ” indicates the HcJ of the sintered R-T-B based magnets that had been subjected to the cooling process under the cooling conditions (1) to (9), respectively.

TABLE 2

| Cooling condition | |
|---|---|
| (after RH supply-diffusion process) | HcJ (kA/m) |
| (1) from 900° C. to 500° C. at 20° C./min | 1990 |
| (2) from 900° C. to 500° C. at 15° C./min | 2005 |
| (3) from 900° C. to 500° C. at 10° C./min | 2048 |
| (4) from 900° C. to 500° C. at 5° C./min | 2096 |
| (5) from 900° C. to 500° C. at 4° C./min | 2114 |
| (6) from 900° C. to 500° C. at 3° C./min | 2128 |
| (7) from 900° C. to 500° C. at 2° C./min | 2142 |
| (8) from 900° C. to 500° C. at 1° C./min | 2147 |
| (9) from 900° C. to 500° C. at 80° C./min | 1985 |

As can be seen from Table 2, compared to Condition (9) for rapidly cooling the temperature in the process vessel from 900° C. to 500° C. at a rate of 80° C./min, HcJ could be increased more effectively by adopting Conditions (1) through (8) for cooling the temperature in the process vessel from 900° C. to 500° C. at a rate of 20° C./min to 1° C./min. Also, HcJ could be increased more effectively by adopting a cooling condition of 15° C./min or less (i.e., any of Conditions (2) through (8) in Table 2). That is why the temperature (of 800° C. to 950° C.) in the process vessel right after the RH supply-diffusion process had been carried out is suitably cooled to 500° C. at a cooling rate of 1° C./min to 15° C./min. Furthermore, no matter whether the cooling condition of 2° C./min (Condition (7) in Table 2) or the cooling condition of ° C./min (Condition (8) in Table 2) was adopted, the HcJ increasing effect was almost no different. Consequently, considering the HcJ increasing effect and productivity, the cooling rate is more suitably 2° C./min to 5° C./min, and most suitably, 2° C./min to 3° C./min.

### INDUSTRIAL APPLICABILITY

A method for producing a sintered R-T-B based magnet according to the present disclosure can be used effectively in various kinds of motors.

### REFERENCE SIGNS LIST

1 process vessel
2 sintered R-T-B based magnet body
3 RH diffusion source
4 holding member
5 multilayer structure

1: A method for producing a sintered R-T-B based magnet, the method comprising the steps of:
stacking RH diffusion sources (each being a metal or alloy, of which at least 80 at % is a heavy rare-earth element RH that is at least one of Dy and Tb) and sintered R-T-B based magnet bodies (where R is at least one of the rare-earth elements and T is at least one of the transition metal elements and always includes Fe) alternately one upon the other with a flat plate holding member having openings interposed between each pair of the diffusion source and the magnet body, thereby forming a multilayer structure;
loading the multilayer structure in a process vessel;
(A) performing an RH supply-diffusion process at a pressure of 2.0 Pa to 50 Pa and at a temperature of 800° C. to 950° C. in the process vessel; and
(B) performing an RH diffusion process at a pressure of 150 Pa to 2 kPa and at a temperature of 800° C. to 950° C. in the process vessel, and
wherein the method includes the step of carrying out the steps (A) and (B) alternately and repeatedly at least twice.

2: The method of claim 1, wherein the holding member has a thickness of 0.1 mm to 4 mm.

3: The method of claim 1, comprising the step of cooling the temperature in the process vessel to 500° C. at a cooling rate of 1° C./min to 15° C./min after the steps (A) and (B) have been alternately carried out at least twice.

4: The method of claim 1, wherein the process vessel is subjected to an evacuation process using either a rotary pump alone or a rotary pump and a mechanical booster pump in combination.
